(19) United States
(12) Patent Application Publication
(10) Pub. No.: US 2003/0120775 A1
(43) Pub. Date: Jun. 26, 2003

(54) Method and apparatus for sending address in the message for an e-mail notification action to facilitate remote management of network devices

(75) Inventor: Justin E. York, Houston, TX (US)

Correspondence Address: AKIN, GUMP, STRAUSS, HAUER & FELD, L.L.P., 300 WEST 6TH STREET, SUITE 2100, AUSTIN, TX, 78701, US

(73) Assignee: COMPAQ COMPUTER CORPORATION

(21) Appl. No.: 10/360,893

(22) Filed: Feb. 7, 2003

Related U.S. Application Data
(63) Continuation of application No. 09/098,016, filed on Jun. 15, 1998.

(51) Int. Cl. G06F 15/173; G06F 15/16

(52) U.S. Cl. 709/224; 709/206

(57) ABSTRACT

A method and apparatus for sending notifications to a user of a network management system concerning the status of a particular network device such as an SNMP manageable device. The. notification rules are preconfigured and assigned to a corresponding notification action such as an e-mail notification. The user may specify a variety of information to be included in the e-mail notification including the URL address of the network device. Once the notification actions are configured, the communications network is monitored by a management console and the state of each device is compared to the notification rules. When a notification rule is satisfied, the pre-configured e-mail notification is sent to the user. The URL for the device which sent the e-mail notification is placed in the body of the e-mail message so that the user, while reading the e-mail with an HTTP compliant URL-aware mail tool, may click on the URL to access the web-based management system for the device. Then the user can obtain current information concerning the device even though the user may be in a remote location.

### CROSS REFERENCE TO RELATED APPLICATIONS

This application is a continuation of U.S. patent application Ser. No. 09/098,016, filed Jun. 15, 1998, pending, all of which is incorporated by reference herein in it's entirety.

This application is related to the following U.S. patent application Ser. Nos.:

U.S. application Ser. No. 09/098,030 entitled “Method and Apparatus for Graphical Display of Multiple Network Monitors over Multiple Intervals” (Attorney Docket No. 044216.0107), filed Jun. 15, 1998, pending;

U.S. application Ser. No. 09/098,027 entitled “Method and Apparatus for Automatic Monitoring of Simple Network Management Protocol Manageable Devices” (Attorney Docket No. 044216.0105), filed Jun. 15, 1998, pending;

U.S. application Ser. No. 09/098,031 entitled “Method and Apparatus for Verifying Network Devices using Simple Network Management Protocol” (Attorney Docket No. 044216.0109), filed Jun. 15, 1998, pending; and

U.S. application Ser. No. 09/098,026 entitled “Method and Apparatus for Discovering Network Devices using Internet Protocol and Producing a Corresponding Graphical Network Map” (Attorney Docket No. 044216.0110), filed Jun. 15, 1998, pending.

All of the above applications are assigned to the assignee of the present invention, and are hereby incorporated herein in their entirety by this reference thereto.

### BACKGROUND OF THE INVENTION

1. Technical Field of the Invention

The present invention relates to the field of computer network systems, and more particularly, but not by way of limitation, to a method and apparatus for notifying a remote user of the status of one or more network devices.

2. Description of Related Art

Communication networks have changed the way people communicate, distribute, and share information. There are many different ways information can be accessed, shared, or communicated on a network. For example, communication networks are being used to access software applications running on a fileserver, to send e-mail to someone in another country, and to access information on remote computer servers.

A network consists of many different devices connected together in some form to allow one device to benefit from another. These devices include but are not limited to switches, routers, repeaters, hubs, terminals, servers, queuing devices, and peripheral equipment such as printers, modems, and scanners.

Communication networks allow the user to access remote programs and remote databases either of the same organization or from other enterprises or public sources. They also provide communication possibilities faster than other facilities. Because of these optimal information and communication possibilities, communication networks will often increase the organizational learning rate, which many authors declare to be the only fundamental advantage in competition.

These benefits do not come without their problems though. A network system can be very complex, rendering solutions to network problems difficult to identify. This is due to the fact that it is usually trying for the user to spot the source of a problem in a complex network using only the consequences of the problem. To help cope with this difficulty, network management systems have been developed to monitor a network and identify problems or potential problems with the network.

Network management systems provide the user with a tool to spot a problem with a network device and correct the problem before it becomes fatal. Notification actions, triggered by certain user-defined conditions, are used by the network management system to give notice to the user that a particular condition has occurred. Sometimes, however, the user may not be readily available and thus a notification on the system itself will not give timely feedback to the user. Hence, the advantage of using the network management system is defeated because the user is not given the feedback needed to solve the problem before the network device causes greater difficulties.

To make cost-effective decisions, the remote user needs easy access to current information concerning the particular condition of a device. Current network management systems do not satisfy this need. Because of the time that it takes to find the problem on a network using such a network management system, some consumers will elect to forego the advantages of using such a system. Consequently, there is a market for network management systems which are more readily accessible and easier to use. Any tool which saves the user time and makes it easier to determine the specifics of a network problem enhances the utility of a network management system.

### BRIEF DESCRIPTION OF THE DRAWINGS

A more complete understanding of the present invention may be had by reference to the following Detailed Description and appended claims, when taken in conjunction with the accompanying Drawings wherein:

FIG. 1 is a functional block diagram of an apparatus for effectuating the monitoring of multiple network and other Simple Network Management Protocol manageable devices and sending notification actions to the remote user; and

FIG. 2 is a flow diagram of a method for effectuating the monitoring of multiple network and other Simple Network Management Protocol manageable devices and sending notification actions to the remote user consistent with the apparatus described in FIG. 1.

### DETAILED DESCRIPTION OF THE DRAWINGS

The present invention fulfills the need for speed in obtaining current information concerning a network device while a user is in a remote location. This is accomplished by providing an e-mail notification to the user whenever a network management system detects a notification-triggering event. The triggering events are chosen by the user when a e-mail notification action is configured. When the user gets the e-mail notification, a management console of the system may be accessed to obtain more information concerning the triggering device. However, physically approaching the management console of the network system can take much time especially if the user is not in close proximity to the console. In that case, a web browser may be launched to enable the user to navigate to a website of the network management system to get information concerning port-level statistics, configurations, and system information. Once at the network management website, the user can search for the problematic device to find real-time information concerning the device. Some users may not even have the time it takes to load the web browser and search for the troubled network device and thus may elect to forego using the network management system.

The present invention saves the user more time by allowing the user to configure the e-mail notification action so that the text of the message that is sent contains an address which points to the web-based management of the particular device. When using a Hypertext Transfer Protocol (HTTP) compliant URL-aware mail tool, the user may simply click on a Uniform Resource Locator (URL) in the e-mail message to launch the web browser and access the troubled device directly. This makes it much easier and therefore less time-consuming for the user to access network information concerning the particular device which caused the notification to be sent.

According to an embodiment of the present invention, a system for managing a network includes a management console which monitors the devices connected to the network and notifies the user when a pre-defined condition called a notification rule is satisfied. The user configures the types and content of notifications that the user wishes to receive from the network management system. The network management system then monitors the specified devices and performs the appropriate actions when the notification rules are satisfied. In particular, the user configures an e-mail notification action by specifying to whom the e-mail message is to be sent, the subject of the e-mail message, and the contents of the e-mail message. In the contents of the e-mail message, the user may choose from several different variables which are available internally to the management console when the notification action is triggered. This may include, among other things, a description of the device, a description of what just happened to the device, an event classification whether it was major or minor, or a map on which the device is located.

The present embodiment of the invention adds an additional variable that the user may select when configuring the e-mail notification action. This variable is used to place into the body of the e-mail message the address, more specifically a Universal Resource Locator (URL), of the device triggering the notification action. Thus, in mail packages which support the Hypertext Transport Protocol (HTTP) compliant URLs, the user may single-click on the URL that appears in the e-mail message to automatically launch a web browser and go directly to a web-based management system for the device. This eliminates the need for the user to search for the device.

According to another embodiment of the present invention, a method for providing easier and quicker access to network management of a particular device includes placing the address of a device that triggers a notification action into an e-mail message and sending the message to a pre-specified address. A user may, while reading the e-mail message, click on a hypertext link in the message to launch a web-based network management system and directly access information concerning the device.

Technical features of embodiments of the present invention include the ability to access the web-based management system and access information concerning the device that triggered the notification action without manually spawning the web browser and searching for the device. Specifically, the present invention enhances the effectiveness of the network management system by dramatically reducing the time required for the user to get useful feedback from the system. Another technical advantage of the present. invention is that during the setup of the network management system, the user need only insert a variable rather than the actual address of a device when configuring the e-mail notification action. In this way, the network management system determines the actual address of a device when the notification action is triggered by the device. Thus the user need not configure the notification action for every single device. Also, the user need not be concerned with the actual address or URL for any of the networked devices. In the present invention, this information is available internally to the network management system when the notification action is triggered. Another technical advantage of the present invention is that the HTTP-compliant URL of the device may be used in the e-mail notification so that the link is highlighted in a different color when the mail is read using an HTTP compliant URL-aware mail tool.

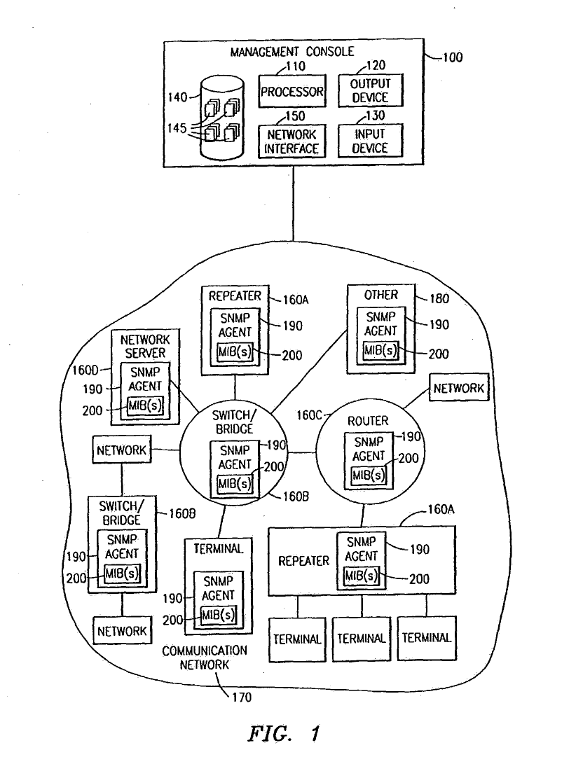

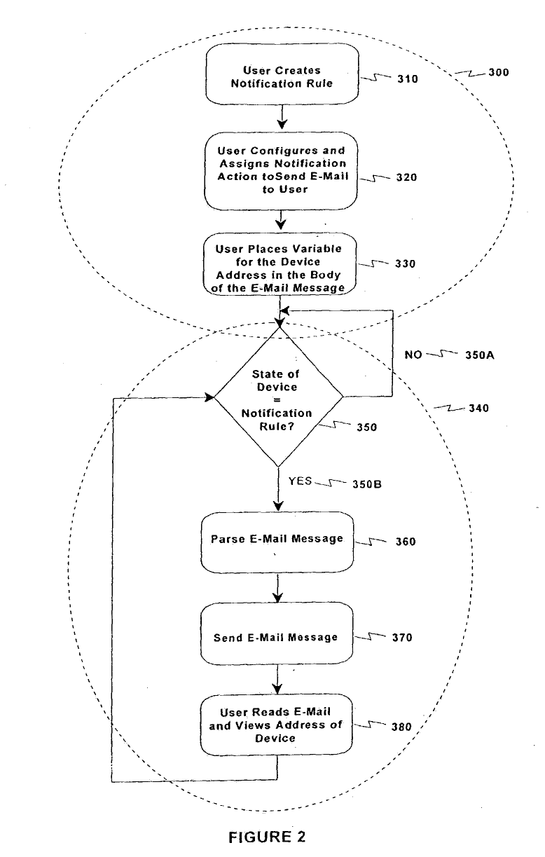

One embodiment of the present invention and its advantages are best understood by referring to FIGS. 1-2 of the Drawings, like numerals being used for like and corresponding parts of the various Drawings.

Referring now to FIG. 1, there is illustrated a functional block diagram of an apparatus for effectuating the monitoring of multiple network and other Simple Network Management Protocol (SNMP) manageable devices and sending notifications to the user. An example of the utilization of the present invention can be found in Compaq's Netelligent Management Software, the user guide of which (5th edition) is incorporated herein by reference.

As depicted in FIG. 1, a management console 100 comprising a processor 110, an output device 120 such as a video display or a printer, an input device 130 such as a keyboard or floppy disk drive, a storage device 140 such as Random Access Memory (RAM) or a disk drive, and a network interface 150 communicates with various network devices 160 and other devices 180 across a communication network 170.

Various network devices 160 reside within the communication network 170 and are manageable using Simple Network Management Protocol (SNMP). SNMP is a communication network management protocol which is commonly known in the industry. SNMP defines a set of variables that an entity in a communication network maintains and consists of three parts: a Structure of Management Information (SMI), a Management Information Base (MIB), and the protocol itself. Although various versions of SNMP may exist, the present invention is equally applicable to each version.

The network devices 160 include, but are not limited to, such devices as repeaters 160A, switch/bridges 160B, routers 160C, and network servers 160D. Various other 10 devices 180 may also reside within the communication network 170 which are manageable using SNMP but which are not necessarily “communication network” type devices. Examples of other devices 180 include, but are not limited to workstations and printers.

Within each SNMP manageable device, which includes network devices 160 and other devices 180, resides an SNMP agent 190. The SNMP agent 190 implements one or more MIB(s) 200 which contain the set of variables or database needed to monitor and control components in the communication network 170 such as, but not limited to, the network devices 160 and other devices 180. Using SNMP, the processor 110 located within the management console 100 accesses the SNMP agents 190 to retrieve information contained within the MIBs 200. The processor 110 stores the information within storage files 145 located within the storage device 140.

Referring additionally now to FIG. 2, there is illustrated a flow diagram of a method for effectuating the monitoring of multiple network and other Simple Network Management Protocol manageable devices and sending notification actions to the remote user consistent the apparatus described in FIG. 1. Before the monitoring process begins, the user configuration 300 must be accomplished. First the user must create a notification rule for each condition for which the user desires to trigger a notification action 310. The user can create a notification rule based on numerous conditions such as the state of a particular device whether it be on or off, the load placed on a device, or the errors caused by a device. While configuring the system, the user must also select the type of notification action that is to take place when the particular condition occurs. Here the user configures a notification action to send e-mail to the user and assigns it 320 to the rule created in the previous step 310. The configuration of the e-mail notification action may include such things as the user's e-mail address, the subject line of the e-mail, and the body of the e-mail message. In order to provide a URL within the body of the e-mail message, the user must enter the variable which represents the “Device URL” when configuring the e-mail notification action 330. Other variables may also be selected such as a description of the device or a description of what just happened to the device. All of these variables represent information which is available in the system when the notification action is triggered.

Once the user has configured the system, the monitoring and notification process is activated 340. The network is constantly monitored by comparing the state of the devices to the notification rule set by the user 350. A notification action is not triggered until the state of the device is equivalent to the condition set by the user in the notification rule. When the condition occurs 350B, the e-mail notification action is triggered. The body of the pre-configured e-mail message is parsed and each variable within the e-mail message is replaced with the value of the variable at the time the notification action is triggered 360. The variable inserted by the user for the device address 330 is replaced with the URL of the device that triggered the notification action. The system then accesses a Simple Mail Transfer Protocol (SMTP) server and sends the e-mail message 370. Upon receiving the e-mail, the user may read the e-mail and view the address of the device which triggered the notification action 380 along with any other information that the user chose to send during the configuration of the notification action 320. In an e-mail tool which supports HTTP compliant URLs, the URL address for the device will be highlighted and the user may simply click on the highlighted address to go directly to the web-based management for the device. When the notification action is completed, the management system continues to monitor the network looking for other conditions which meet a user-defined notification rule 350.

In a preferred embodiment of the invention, network management software is loaded into the disk drive 140 of the management console 100. Before the software begins monitoring the communication network 170, dialog boxes for configuring the notification rules and actions 320 are provided to the user. This stage is called the definition stage 300. In this stage, the user chooses the device conditions, called notification rules, for which notification actions should be triggered. The user may choose, among other things, to set up an e-mail notification action. A menu of device variables is provided to the user, and from this menu, the user chooses certain variables to be displayed when the notification action is triggered. In particular, a variable entitled “Device URL” may be selected from the menu. When this variable is selected during the definition stage, the token “$deviceurl” is placed into the body of the e-mail message. The user also specifies the subject and addressee of the e-mail. After the notification action is configured, the network management system begins monitoring the devices using the Simple Network Management Protocol (SNMP). When one of the notification rules established by the user in the definition stage is satisfied, the notification action corresponding to that rule is triggered. The pre-configured e-mail notification action is then parsed and the tokens found within the e-mail are replaced with the actual value of the variable. Specifically, the token “$deviceurl” is translated using a translate function and replaced with the actual web-based management URL for the device. The HTTP-compliant URL is basically a constant except for the device ID from the particular event and the fP address for the web-based management console. Thus most of the URL may be hard coded in the source code implementation because it will always remain the same so that when a notification action is triggered, only the device ID and the IP address is passed to the translate function. The ID is then concatenated with the constant portion of the URL and placed into the e-mail message in place of the “$deviceurl” token. Then the e-mail message is sent to the address previously specified by the user.

Although a preferred embodiment of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. A method for notifying a user of the status of at least one network device in a communications network, said method comprising the steps of:
monitoring the at least one network device to at least determine if a notification rule is satisfied; and if a notification rule is satisfied,
creating an e-mail message corresponding to the notification rule, the e-mail message including an address pointing to the at least one network device; and
sending the e-mail message to the user.

2. The method of claim 1 wherein said step of creating an e-mail message further comprises the step of pre-configuring the e-mail message to include one or more variables representing information available in the communications network.

3. The method of claim 2 wherein said step of creating an e-mal message further comprises the steps of:
parsing the pre-configured e-mail message; and replacing the one or more variables with the actual values of the one or more variables.

4. The method of claim 1 wherein the at least one network device is manageable using the Simple Network Management Protocol (SNMP).

5. The method of claim 1 wherein the address pointing to the at least one network device is a Uniform Resource Locator (URL).

6. The method of claim 5 wherein the user opens the e-mail message using an HTTP compliant URL-aware mail tool and clicks on the URL in the e-mail message to access a graphical interface to the one at least one network device.

7. The method of claim 1 wherein the e-mail message contains an address pointing to the at least one network device satisfying the notification rule.

8. The method of claim 7 wherein the address pointing to the at least one network device is in the form of a Uniform Resource Locator (URL).

9. The method of claim 8 wherein the user opens the e-mail message using an HTTP compliant URL-aware mail tool and clicks on the URL in the e-mail message to access a graphical interface to the at least one network device.

10. A method for sending an e-mail notification to a user corresponding to the status of at least one network device in a communications network, said method comprising:
creating at least one notification rule;
configuring an e-mail notification action to correspond to the at least one notification rule;
placing at least one variable representing characteristics of the at least one network device into a body of the e-mail notification action;
monitoring the at least one network device; and if the at least one notification rule is satisfied:
parsing the body of the configured e-mail notification action;
replacing the at least one variable in the body of the e-mail notification action with an actual value represented by the at least one variable to get the e-mal notification rule, wherein one of the at least one variables symbolizes an address of the at least one network device; and
sending the e-mail notification to the user.

11. The method of claim 10 wherein the address of the at least one network device is a Uniform Resource Locator (URL).

12. The method of claim 10 wherein the at least one network device is manageable using the Simple Network Management Protocol (SNMP).

13. A network management system for notifying a user of the status of at least one network device connected in a communications network, said network management system comprising:
a management console connected to the communications network wherein the management console monitors the at least one device to determine if at least one notification rule is satisfied;
a first module within said management console for sending an e-mail message to the user when the at least one notification rule is satisfied;
a second module for ascertaining the address of the at least one network device satisfying the at least one notification rule; and
a third module for placing the address ascertained by said second module into the e-mail message to be sent by said first module.

14. The system of claim 13 further comprising a fourth module within said management console for pre-configuring an e-mail message to be sent to the user when the at least one notification rule is satisfied.

15. The system of claim 14 further comprising a fifth module within said management console for parsing the pre-configured e-mail message and replacing the at least one variable with an actual value of the variable.

16. The system of claim 13 wherein the at least one network device supports the Simple Network Management Protocol (SNMP).

17. The system of claim 13 further comprising a fourth module for providing a remote user with a graphical interface to the network management system.

18. The system of claim 13 wherein said first module is an HTTP compliant URL-aware mail tool.
